(19) United States
(12) Patent Application Publication
(10) Pub. No.: US 2026/0246015 A1
(43) Pub. Date: Aug. 20, 2026

(54) SECONDARY BATTERY MODULE INCLUDING COOLING STRUCTURE AND SECONDARY BATTERY PACK

(71) Applicant: SAMSUNG SDI CO., LTD., Yongin-si (KR)

(72) Inventor: Youngho Choi, Yongin-si (KR)

(21) Appl. No.: 19/392,992

(22) Filed: Nov. 18, 2025

(30) Foreign Application Priority Data
Feb. 18, 2025 (KR) 10-2025-0021077

(51) Int. Cl. H01M 10/6557; H01M 10/613; H01M 10/6551; H01M 10/6568; H01M 50/209; H01M 50/242; H01M 50/367

(52) U.S. Cl. CPC H01M 10/6557; H01M 10/613; H01M 10/6551; H01M 10/6568; H01M 50/209; H01M 50/242; H01M 50/367

(57) ABSTRACT

A secondary battery module includes a plurality of battery cells, a module case having a plurality of cell pockets into which the battery cells are fitted and a coolant passage outside the cell pockets through which a coolant flows to cool the battery cells in the cell pockets, and a coolant circulation part connected to the module case and configured to move the coolant through the coolant passage inside of the module case.

### CROSS-REFERENCE TO RELATED APPLICATION

The present application claims priority to and the benefit of Korean Patent Application No. 10-2025-0021077, filed on Feb. 18, 2025, in the Korean Intellectual Property Office, the entire disclosure of which is incorporated herein by reference.

### BACKGROUND

### 1. Field

Aspects of embodiments of the present disclosure relate to a secondary battery module including a cooling structure and a secondary battery pack.

### 2. Description of the Related Art

Secondary batteries are batteries that are designed to be charged and discharged, unlike primary batteries that are not designed to be recharged. A battery cell, which is a basic unit constituting a secondary battery, includes an electrode assembly including (or formed of) electrode plates of positive and negative electrodes (e.g., positive and negative electrode plates), a battery case (or can) for accommodating the electrode assembly, an electrode terminal connected to the electrode assembly, a vent for degassing excess gas generated inside the case, etc. Recently, secondary batteries are being used for motor driving and power storage in hybrid vehicles, electric vehicles, etc., and are increasing capacity.

Because a secondary battery module or a secondary battery pack in which a plurality of battery cells are accommodated generates a substantial amount of heat during operation, heat dissipation is a design consideration. Various cooling technologies for efficiently cooling a secondary battery pack are known, such as a water-cooled type (e.g., a water-cooling system) that circulates a coolant.

In the case of a water-cooled secondary battery module, the coolant flows a along a flow path inside a module case. For example, a coolant circulation structure is formed inside the module case, and a battery cell is accommodated therein. Such a configuration, however, increases the overall volume of the module. In addition, in the case of a water-cooled secondary battery pack for an electric vehicle, the coolant flow path may be broken (e.g., ruptured) or damaged by an external impact from the road while traveling.

The above information disclosed in this Background section is for enhancement of understanding of the background of the present disclosure, and therefore, it may contain information that does not constitute the related (or prior) art.

### SUMMARY

Embodiments of the present disclosure provide a secondary battery module and a secondary battery pack in which a module case of the secondary battery module has a structure for cooling a battery cell while having a compact configuration and reduced volume while protecting the battery cell and a coolant flow path from an external impact to prevent a problem, such as a coolant leak or the like.

According to an embodiment of the present disclosure, a secondary battery module includes a plurality of battery cells, a module case having a plurality of cell pockets into which the battery cells are fitted and a coolant passage outside the cell pockets through which a coolant flows to the battery cells in the cell pockets, and a coolant circulation part connected to the module case and configured to move the coolant through the coolant passage inside of the module case.

According to another embodiment of the present disclosure, a secondary battery pack includes: a secondary battery module including a plurality of battery cells, a module case having a plurality of cell pockets into which the battery cells are fitted and a coolant passage outside the cell pockets through which a coolant transfers to the battery cells in the cell pockets, and a coolant circulation part connected to the module case and configured to move the coolant through the coolant passage inside of the module case; and a pack housing accommodating the secondary battery module.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The above and other aspects and features of the present disclosure will become more apparent to those of ordinary skill in the art by describing embodiments thereof, in detail, with reference to the accompanying drawings, in which:

FIG. 1 is a perspective view of a battery cell to be accommodated in a secondary battery module according to an embodiment of the present disclosure;

FIG. 2 is a layout view describing a structure of a secondary battery module according to an embodiment of the present disclosure;

FIG. 3 is a cutaway perspective view illustrating a structure of a module case shown in FIG. 2;

FIG. 4 is a plan view illustrating a structure of the module case shown in FIG. 3;

FIG. 5 is a cross-sectional view taken along the line A-A in FIG. 4;

FIG. 6 is a cross-sectional view describing a cooling principle of the battery cell in the module case shown in FIG. 2;

FIG. 7 is a cross-sectional view illustrating a module case according to another embodiment;

FIG. 8 is a cutaway view illustrating a buffer unit under the module case shown in FIG. 3;

FIG. 9 is an enlarged view of the portion A in FIG. 8;

FIG. 10 is a cross-sectional view illustrating an internal configuration of the buffer unit shown in FIG. 8;

FIG. 11 is a partially enlarged view describing the operation of the buffer unit shown in FIG. 10;

FIG. 12 is a configuration diagram illustrating a secondary battery module according to another embodiment of the present disclosure;

FIG. 13 is an exploded perspective view of a module case shown in FIG. 12;

FIG. 14 is a cross-sectional view illustrating a flow of a cooling fluid in the secondary battery module shown in FIG. 12;

FIG. 15 is a cross-sectional view taken along the line C-C in FIG. 12;

FIG. 16 is a perspective view illustrating a battery cell applicable to the secondary battery module according to an embodiment of the present disclosure;

FIG. 17 is a configuration diagram of a secondary battery module to which the battery cell shown in FIG. 16 is applied;

FIG. 18 is a perspective view of the module case shown in FIG. 17;

FIG. 19 is a cross-sectional view of the module case shown in FIG. 18;

FIG. 20 is a view describing a cooling method of the battery cell in the secondary battery module shown in FIG. 17;

FIGS. 21 to 23 are views of portions in surface contact with a battery cell in a module case according to embodiments of the present disclosure;

FIG. 24 is a perspective view of a secondary battery pack according to an embodiment of the present disclosure; and

FIG. 25 is a view illustrating a secondary battery pack according to an embodiment of the present disclosure which is applied to a vehicle.

### DETAILED DESCRIPTION

Hereinafter, embodiments of the present disclosure will be described, in detail, with reference to the accompanying drawings. The terms or words used in the present specification and claims should not be narrowly interpreted according to their general or dictionary meanings but should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of about 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

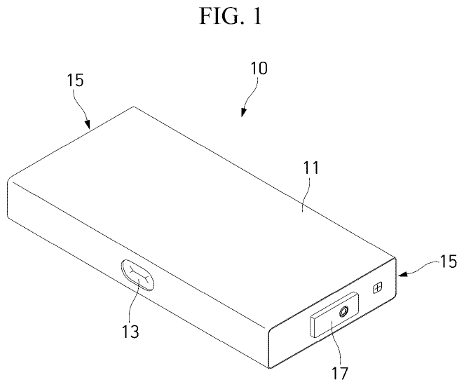

FIG. 1 is a perspective view illustrating a battery cell 10 to be accommodated in a secondary battery module 20 according to an embodiment of the present disclosure for reference.

A battery can (also referred to as a battery case) 11 may form the overall exterior of a secondary battery and may be formed of a conductive metal, such as aluminum, an aluminum alloy, or nickel-plated steel. Both ends of the battery can 11 may be open to accommodate an electrode assembly therein.

Cap assemblies 15 are elements that cover (e.g., seal) the open ends of the battery can 11 and include terminals 17. The terminals 17 are located on the cap assemblies 15 located at both sides of the can 11, respectively. The terminal 17 at one side is electrically connected to a positive electrode of the internal electrode assembly, and the terminal at the other side is electrically connected to a negative electrode thereof. In addition, a vent hole (e.g., a vent opening) 13 for degassing excess gas generated inside the battery is formed in one surface of the battery can 11.

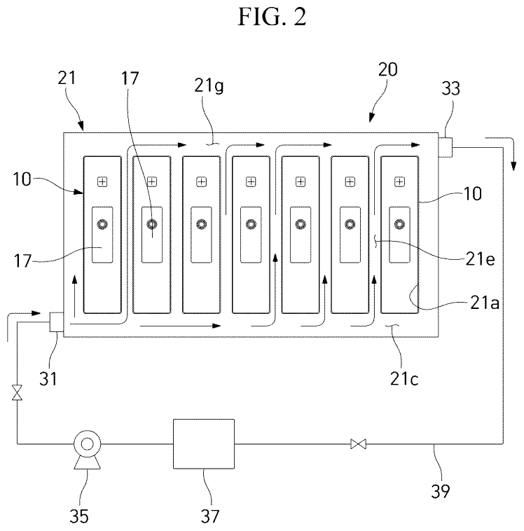

FIG. 2 is a configuration diagram describing a structure of the secondary battery module 20 according to an embodiment of the present disclosure.

Referring to FIG. 2, the secondary battery module 20 may include a plurality of battery cells 10, a module case 21, and a coolant circulation part (e.g., a coolant circulation structure).

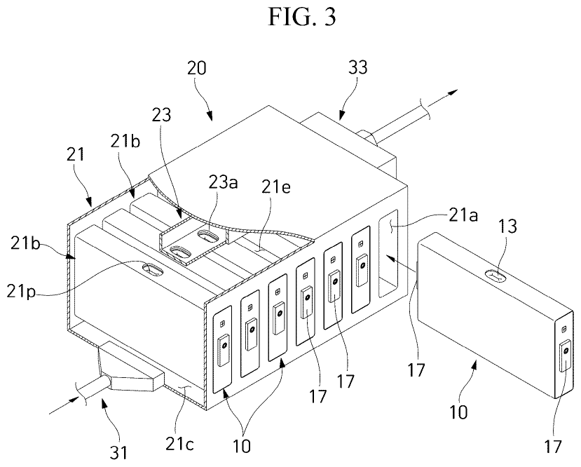

The module case 21 may include a plurality of cell pockets 21b (see, e.g., FIG. 3) that may accommodate the battery cells 10. Each cell pocket 21b is a space forming a cell mounting space 21a that accommodates the battery cell 10, and both ends thereof are open to the outside. The cell mounting spaces 21a are parallel to each other and spaced a distance (e.g., a regular or predetermined distance) from each other. A space between adjacent ones of the cell mounting spaces 21a is a heat exchange flow path 21e through which a coolant passes. The battery cell 10 may be a side terminal type secondary battery as described with reference to FIG. 1.

The module case 21 is a hollow structure that provides a plurality of cell mounting spaces 21a and allows a coolant to pass through the inside thereof. The coolant passes through the module case 21 and cools an outer surface of the cell pocket 21b. Because the battery cell 10 is stored in (e.g., is accommodated in) the cell mounting space 21a of the cell pocket 21b, the battery cell 10 may be cooled by the coolant. A structure of the module case 21 will be described in more detail with reference to FIGS. 2 to 6.

A coolant passage provided inside the module case 21 is a passage through which the coolant, pumped by the coolant circulation part, passes. The coolant passage may include an inflow flow path 21c, the heat exchange flow path 21e, and a discharge flow path 21g.

The inflow flow path 21c is a passage through which the coolant supplied by the coolant circulation part is received and guided. The coolant introduced into the module case 21 may first be introduced into (e.g., may first enter) the inflow flow path 21c. In addition, the heat exchange flow path 21e is a passage connected to (e.g., in fluid communication with) the inflow flow path 21c. The heat exchange flow path 21e is a space between adjacent cell pockets 21b.

A coolant passing through the heat exchange flow path 21e may be in contact with the cell pocket 21b and may cool the cell pocket 21b. In addition, the discharge flow path 21g is a passage through which the coolant that has passed through the heat exchange flow path 21e is received, guided, and discharged to the outside of the module case 21. As a result, the coolant passes through the module case 21, is heat-exchanged with the module case 21, and is then discharged to the outside of the module case 21.

The coolant circulation part may continuously supply a coolant to the module case 21. The coolant circulation part may include a circulation tube 39, a cooler 37, and a pump 35. The circulation tube 39 is a pipe, one end of which is connected to the inflow flow path 21c and the other end of which is connected to the discharge flow path 21g. A coolant that has been discharged from the discharge flow path 21g may move toward the inflow flow path 21c through the circulation tube 39. Reference numerals 31 and 33 denote connectors (e.g., fittings) that connect the end of the circulation tube 39 to the module case 21.

In addition, the pump 35 may continuously pump a coolant. The coolant is pumped by the pump 35 and circulates along the path. In addition, the cooler 37 may cool the coolant moving toward the inflow flow path 21c. The cooler 37 re-cools a coolant heated while passing through the module case 21.

A circulation direction of the coolant circulated by the coolant circulation part is adjustable. For example, the coolant may pass through the module case 21 through the connector 31 at one side and may be discharged to the connector 33 at the other side or, conversely, may be introduced through the connector 33 at the other side and then discharged through another connector 31.

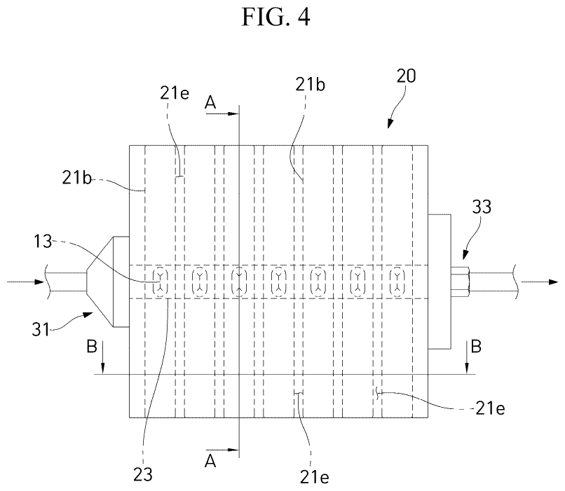

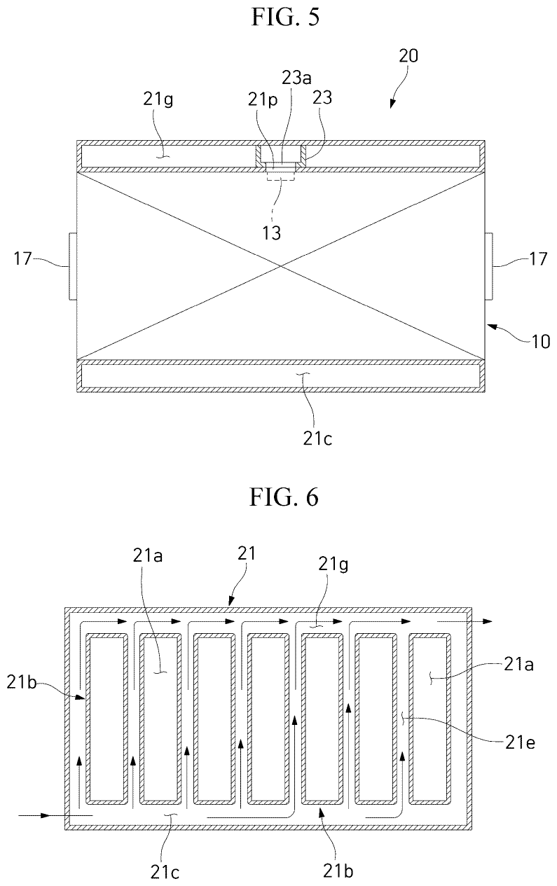

FIG. 3 is a cutaway perspective view illustrating a structure of the module case 21 shown in FIG. 2, FIG. 4 is a plan view illustrating a structure of the module case shown in FIG. 3, and FIG. 5 is a cross-sectional view taken along the line A-A in FIG. 4. In addition, FIG. 6 is a cross-sectional view taken along the line B-B in FIG. 4.

As illustrated, the plurality of cell pockets 21b may be formed inside the module case 21. The cell pocket 21b is formed while manufacturing the hollow module case 21 to form the cell mounting space 21a. The inside of the cell pocket 21b is the cell mounting space 21a. A lower portion of the cell pocket 21b is the inflow flow path 21c, and left and right spaces of the cell pocket 21b are the heat exchange flow paths 21e. In addition, an upper portion of the cell pocket 21b is the discharge flow path 21g. The upper and lower portions and left and right portions of the cell pocket 21b are filled with a coolant.

The module case 21 is a “secondary battery module case” that accommodates and supports the battery cell 10 and also acts as a so-called cooling jacket for cooling a battery cell. To perform such a role, the module case 21 has a hollow shape (e.g., has hollow spaces or features). A conventional water-cooled secondary battery module has a configuration installed using both the module case and the cooling jacket. That is, in the conventional water-cooled secondary battery module, the cooling jacket is installed inside the module case, and the battery cell is installed inside the cooling jacket. The cooling jacket may be a structure that is in surface contact with the battery cell and allows coolant to pass therethrough.

In this way, the secondary battery module 20 according to embodiments of the present disclosure has a compact structure using fewer components because the module case 21 accommodates, supports, and cools the battery cell altogether.

The plurality of cell pockets 21b are parallel to each other and are spaced a distance from each other. As described above, the space between the cell pockets 21b is the heat exchange flow path 21e through which a coolant passes. The inside of each cell pocket 21b, that is, both ends of the cell mounting space 21a, are open to the outside. In addition, the battery cell 10 may be electrically connected to an external electric circuit while being stored inside (e.g., accommodated in) the cell mounting space 21a.

In addition, a through-hole 21p may be formed in a central portion of an upper surface of the cell pocket 21b. The through-hole 21p is a through-hole corresponding to the vent hole 13. In addition, an exhaust duct 23 may be further formed inside the module case 21 to guide any vented gas.

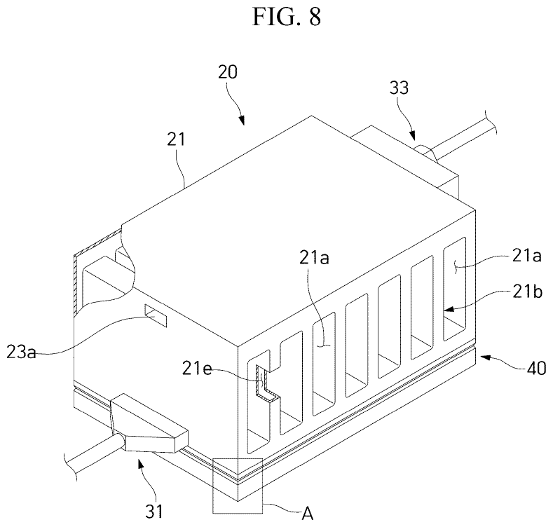

The exhaust duct 23 is a quadrangular duct formed integrally with the upper surface of the cell pocket 21b, and one end thereof opens to the outside of the module case 21 as illustrated in FIG. 8. An internal space of the exhaust duct 23 is sealed so that a coolant cannot flow into the exhaust duct 23. In addition, a vent passage 23a may be formed at the bottom of the exhaust duct 23. The vent passage 23a is a hole (e.g., an opening) corresponding to the through-hole 21p. Accordingly, during thermal runaway of the battery cell 10, gas discharged from the vent hole 13 in the battery cell 10 moves upwardly to the exhaust duct 23 through the through-hole 21p and the vent passage 23a and may then be discharged into the atmosphere.

As a result, as illustrated in FIG. 6, the coolant flowing into the inflow flow path 21c passes through the space between the cell pockets 21b, that is, the heat exchange flow path 21e, moves to the discharge flow path 21g, and then is discharged to the outside. The coolant may be heat-exchanged with the heat discharged from the cell pocket 21b while passing through the module case 21. The coolant cools the battery cell 10.

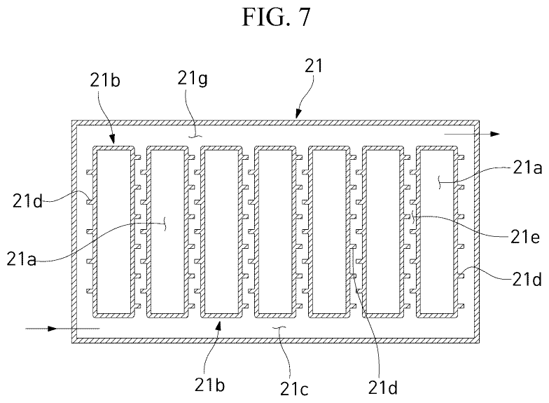

FIG. 7 is a cross-sectional view illustrating a module case 21 according to another embodiment of the present disclosure.

Referring to FIG. 7, a plurality of heat transfer fins 21d may be formed at an outer side of the cell pocket 21b. The heat transfer fin 21d may be a heat radiation fin for (e.g., to improve) heat exchange, which performs heat exchange with the coolant passing through the heat exchange flow path 21e. The heat transfer fin 21d may be formed integrally with the cell pocket 21b and may extend toward the heat exchange flow path 21e. The heat transfer fin 21d increases a heat exchange area. In various embodiments, the shape and/or size of the heat transfer fin may be varied.

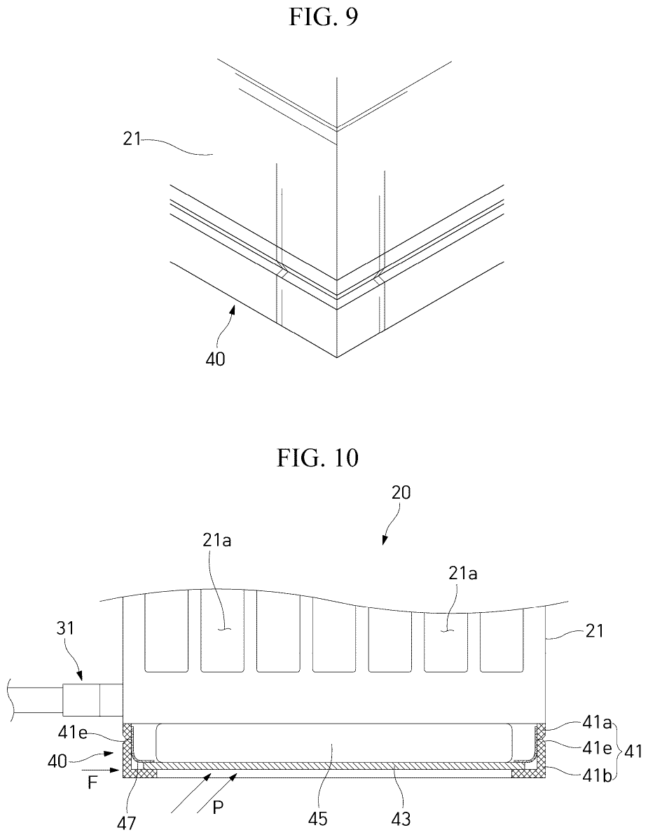

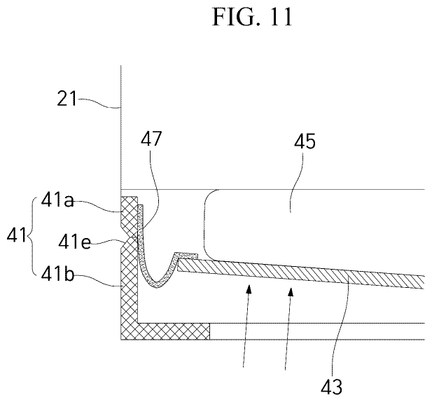

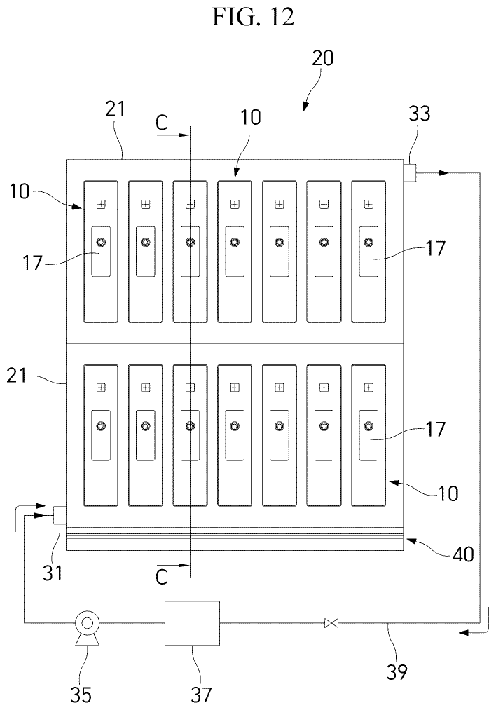

FIG. 8 is a view illustrating a buffer unit 40 under the module case 21 shown in FIG. 3, and FIG. 9 is an enlarged view of the portion A in FIG. 8. In addition, FIG. 10 is a cross-sectional view illustrating an internal configuration of the buffer unit shown in FIG. 8, and FIG. 11 is a partially enlarged view describing the operation of the buffer unit shown in FIG. 10.

The buffer unit 40 may be installed under the module case 21 to buffer (e.g., to absorb or dissipate) an external impact transferred to (or toward) the module case 21. For example, the secondary battery module 20 mounted on an electric vehicle is not damaged or deformed by an impact in the event of an accident while the electric vehicle travels or is damaged less due to the buffer unit. In FIG. 8, the buffer unit 40 is mounted under the module case 21, but in some embodiments, the buffer unit 40 may be (or may also be) installed at a side of or above the module case 21.

The buffer unit 40 may include a protective guard 41, a protective plate 43, a buffer part, and a waterproof membrane 47.

The protective guard 41 is a quadrangular frame-shaped member fixed to a lower portion of the module case 21. The protective guard 41 may accommodate and protect the protective plate 43, the buffer part, and the waterproof membrane 47 that are accommodated in an inner area of the protective guard 41.

The protective guard 41 may include a fixing part (e.g., a mounting part) 41a and a bracket part (e.g., a bracket) 41b. The fixing part 41a is a quadrangular frame-shaped member that is fixedly connected (e.g., welded) to an outer surface of a bottom surface of the module case 21 and formed integrally with an upper end of the bracket part 41b.

The bracket part 41b may have a bracket shape with a lower end bent inwardly. An upper end of the bracket part 41b is formed integrally with the fixing part 41a. In addition, a notch 41e may be formed at a boundary between the fixing part 41a and the bracket part 41b. The notch 41e is a portion that is bent or torn (e.g., that is designed to be bent or torn) when an impact in the direction of the arrow F in FIG. 10 is applied thereto.

The protective plate 43 is a plate-shaped member having a thickness and is provided in the inner area of the protective guard 41 and covers a lower surface of the module case 21. An outer portion of the protective plate 43 is supported while caught on the bracket part 41b. The protective plate 43 and the bracket part 41b are not connected, and the protective plate 43 is simply caught on the bracket part 41b. Accordingly, for example, when a force is applied in the direction of the arrow p in FIG. 10, the protective plate 43 may receive impact energy, press the buffer part, and be lifted up.

The buffer part is, in one embodiment, an airbag 45 that is installed between the bottom surface of the module case 21 and the protective plate 43 and pressed when the protective plate 43 is pushed up. The airbag 45 supports the protective plate 43 downwardly while being interposed between the module case 21 and the protective plate 43. Air or an inert gas may be accommodated inside the airbag 45. The airbag 45 may be formed of heat-resistant rubber or heat-resistant silicone.

The waterproof membrane 47 is a member formed of rubber or silicone sheet, and an upper end thereof may be fixedly bonded to the inside of the fixing part 41a. In addition, a lower end of the waterproof membrane 47 may be fixedly bonded to an upper surface of the outer portion of the protective plate 43. The waterproof membrane 47 is flexible and elastically deformable. The waterproof membrane 47 may seal a gap between the protective guard 41 and the protective plate 43. Accordingly, for example, even when the bottom of the module case 21 is broken and a coolant is discharged (or flows) downwardly, the coolant is blocked by the waterproof membrane 47 and is not discharged downwardly from (e.g., is not discharged out of) the protective guard 41. When the waterproof membrane 47 is omitted, the coolant leaking from the module case 21 may cause an electrical problem in the secondary battery pack.

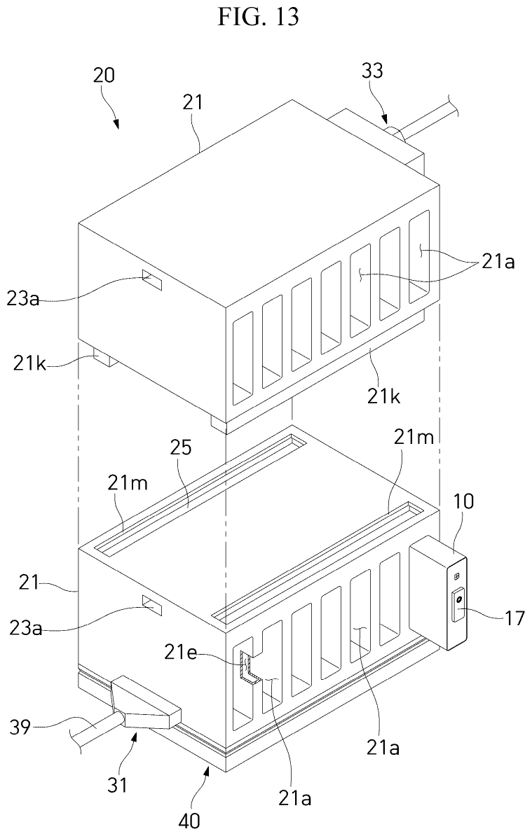

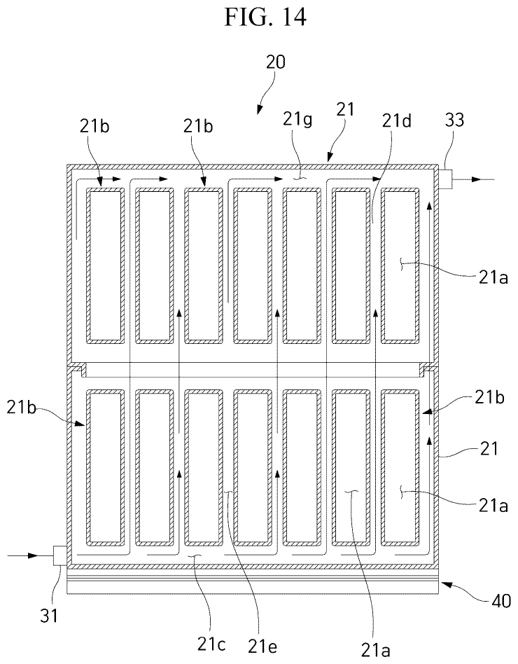

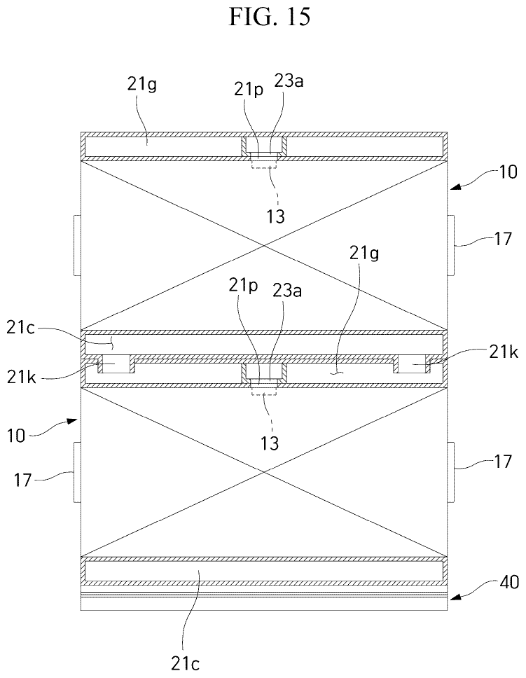

FIG. 12 is a configuration diagram illustrating a secondary battery module according to another embodiment of the present disclosure, FIG. 13 is an exploded perspective view of a module case shown in FIG. 12, and FIG. 14 is a cross-sectional view illustrating a flow of a cooling fluid in the secondary battery module shown in FIG. 12. In addition, FIG. 15 is a cross-sectional view taken along the line C-C in FIG. 12.

As illustrated in FIGS. 12 to 15, two module cases 21 may be stacked to form a two-layer structure. The internal configurations of the upper and lower module cases 21 are the same. The connector 31 of the circulation tube 39 at an inlet side is merely connected to the lower module case 21, and the connector 33 at an outlet side is fixed to the upper module case 21.

In addition, as illustrated in FIG. 13, a duct coupling passage 21m may be provided at both sides of an upper surface of the lower module case 21. The duct coupling passage 21m may be formed to pass through (e.g., to extend through or into) the internal space of the module case 21, that is, the coolant passage, to open upwardly. In the embodiment shown in FIG. 13, the duct coupling passage 21m is formed in a rectangular shape, but embodiments are not limited thereto.

In addition, connection ducts 21k may be provided at both sides of a bottom surface of the upper module case 21. The connection duct 21k is a passage that is fitted and coupled to the duct coupling passage 21m. When the upper module case 21 is mounted on the lower module case 21, the connection duct 21k passes through (e.g., extends into) the duct coupling passage 21m and enters the lower module case 21. In such an embodiment, a seal may be applied between the duct coupling passage 21m and the connection duct 21k to prevent a coolant from leaking from the duct coupling passage 21m.

As a result, the coolant that has flowed into the lower module case 21 through the connector 31 at one side passes through the heat exchange flow path 21e inside the lower module case 21 and then flows into the upper module case 21 through the connection duct 21k. Thereafter, the coolant passes through the upper module case 21 and is discharged through the connector 33. In some embodiments, the circulation direction of the coolant may be reversed. For example, the coolant may have a circulation path in which the coolant flows into the upper module case 21, moves downwardly, and is discharged to the outside after passing through the lower module case 21.

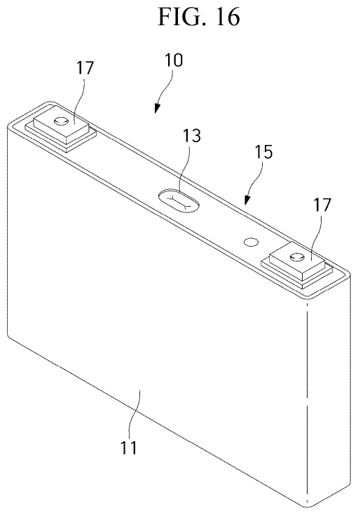

FIG. 16 is a perspective view illustrating a battery cell 10 also applicable to the secondary battery module according to an embodiment of the present disclosure.

The battery cell 10 illustrated in FIG. 16 is a so-called top terminal type secondary battery having the terminals 17 at an upper end thereof. The battery can (or case) 11 forms the overall exterior of the battery cell 10 and may be formed of a conductive metal, such as aluminum, an aluminum alloy, or nickel-plated steel. The battery can 11 may provide an internal space in which an electrode assembly is accommodated.

The cap assembly 15 is an element that covers (e.g., seals) the opening in the battery can 11 and has two terminals 17. The terminals 17 may be electrically connected to negative and positive tabs of the electrode assembly, respectively. In addition, the vent hole (e.g., vent opening) 13 is formed in the cap assembly 15. The vent hole 13 is a hole (e.g., an opening) through which excess gas generated inside the battery cell is discharged. An electrode assembly is mounted inside (e.g., is accommodated in) the battery cell 10.

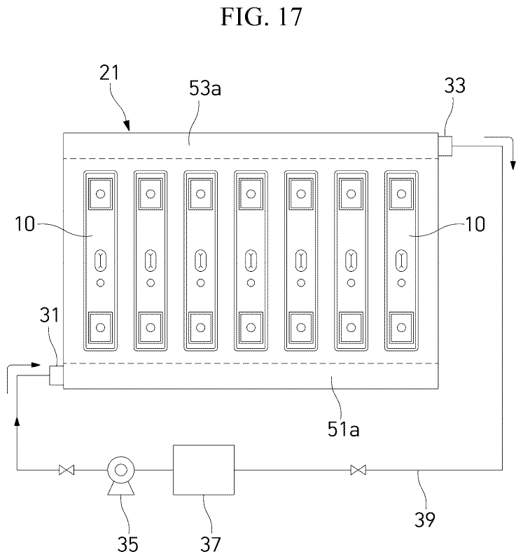

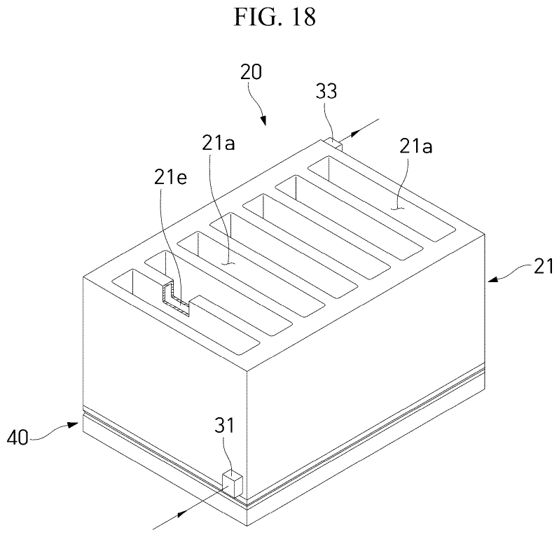

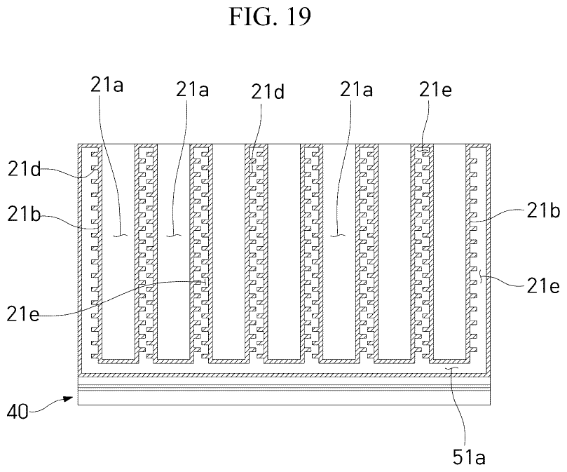

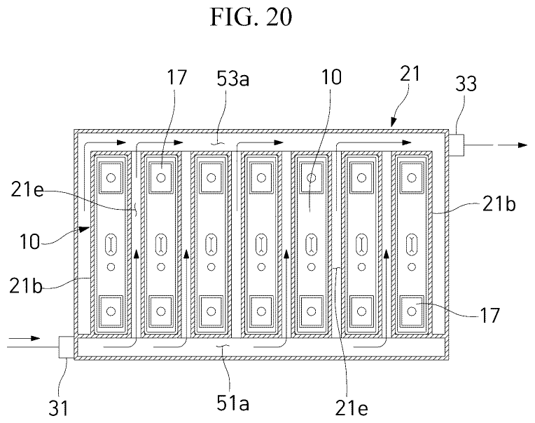

FIG. 17 is a configuration diagram of a secondary battery module to which the battery cell shown in FIG. 16 is applied, and FIG. 18 is a perspective view of the module case illustrated in FIG. 17. In addition, FIG. 19 is a cross-sectional view of the module case shown in FIG. 18. FIG. 20 is a view describing a cooling method of a battery cell in a secondary battery module. Hereinafter, the same reference numerals as introduced above denote the same members having the same functions, and overlapping descriptions thereof will be omitted or only briefly repeated.

Referring to FIG. 17, the plurality of cell mounting spaces 21a that open upwardly may be formed in the module case 21. The cell mounting space 21a may open upwardly so that the terminals 17 of the battery can 11, which will be connected, are located at an upper side. The battery can 11 is fitted into the cell mounting space 21a.

As illustrated in FIGS. 19 and 20, the cell pocket 21b is formed so that all portions excluding an upper portion come into contact with the coolant. For example, a bottom portion of the cell pocket 21b is separated from the bottom surface of the module case 21, and left and right sides thereof are separated from the inner surface of the module case 21. In addition, the neighboring cell pockets 21b are also separated from each other by a distance. The front, rear, left, and right sides and the lower portion of the cell pocket 21b are heat-exchanged in contact with the coolant.

The coolant passage of the module case 21 may include an inflow flow path 51a, a heat exchange flow path 21e, and a discharge flow path 53a. The inflow flow path 51a may receive the coolant introduced through the connector 31 of the coolant circulation part at one side and may guide the coolant to the heat exchange flow path 21e. In addition, the coolant that has passed through the heat exchange flow path 21e is collected in the discharge flow path 53a and then discharged to the outside after passing through another connector 33. The circulation direction of the coolant may be set reversely. For example, the coolant may be injected through the connector 33 and discharged through another connector 31.

In addition, as illustrated in FIG. 19, the heat transfer fin 21d may be formed on the outer surface of the cell pocket 21b. The heat transfer fin 21d increases a heat transfer area between the cell pocket 21b and the coolant and comes into contact with the coolant passing through the heat exchange flow path 21e. The coolant comes into contact with the outer surface of the cell pocket and the heat transfer fin 21d and cools the battery cell 10. Through the above configuration and operation, overheating of the battery cell may be prevented and a stable operation environment may be maintained.

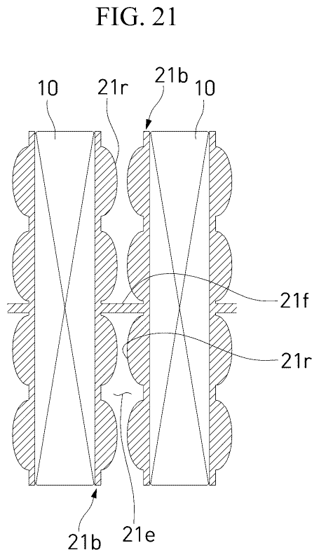

FIGS. 21 to 23 are partial cross-sectional views illustrating surfaces of the cell pocket 21b facing the heat exchange flow path 21e in the module case according to various embodiments of the present disclosure.

As illustrated, a reinforcing part may be formed on a surface of the cell pocket 21b, which faces the heat exchange flow path 21e. The reinforcing part may serve to prevent the cell pocket from being deformed when the battery cell 10 swells.

The reinforcing part illustrated in FIG. 21 may include a plurality of protrusions 21r and reinforcing ribs 21f. The protrusion 21r is a part at where the thickness of a wall forming the cell pocket 21b is partially (or locally) increased. Because strength increases as the thickness increases, the protrusion 21r can more stably respond to a bending force. In addition, the reinforcing rib 21f connects the facing cell pockets 21b to maintain the gap between the facing cell pockets 21b even when swelling occurs. The reinforcing rib 21f has a shape that does not interfere with the flow of a coolant.

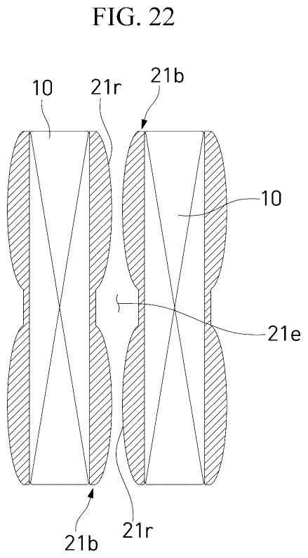

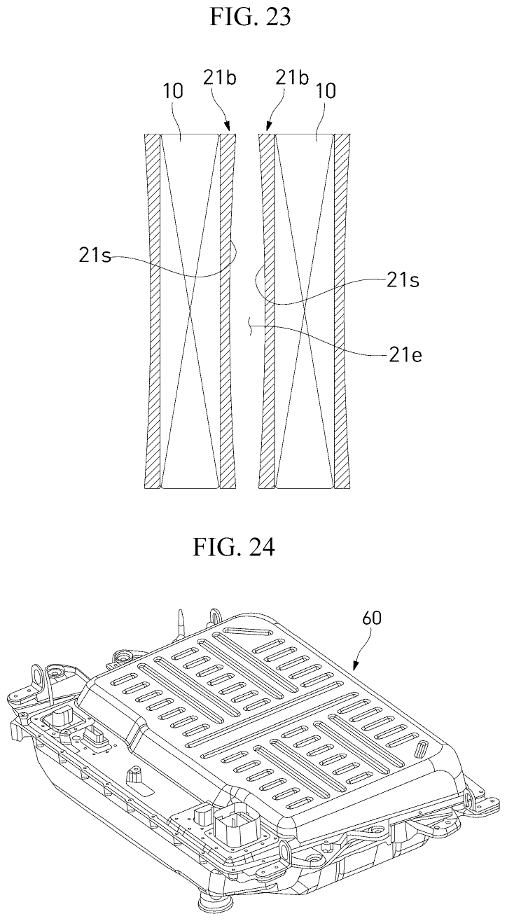

The reinforcing part illustrated in FIG. 22 has two protrusions 21r. In addition, the reinforcing part shown in FIG. 23 includes concave portions 21s. The concave portions 21s are concave portions formed in the facing surfaces of the facing cell pockets 21b. The concave portion 21s prevents the heat exchange flow path 21e from being narrowed and blocked even when the battery cell 10 swells. For example, even when the swelling phenomenon is severe, the heat exchange flow path 21e is not blocked, and thus, the battery cell 10 may be cooled to stop or reduce the swelling.

FIG. 24 is a perspective view of the secondary battery pack 60 according to an embodiment of the present disclosure.

The secondary battery pack 60 may be manufactured by mounting the secondary battery module 20 in a pack housing 61 designed to be mounted on an actual product. The pack housing 61 may include fasteners and electrical outlets for product mounting. In FIG. 24, for convenience of illustration, components including a bus bar, a cooling unit, external terminals for electrically connecting secondary batteries, etc., are not illustrated. The secondary battery pack 60 may be mounted on a vehicle. The vehicle may be, for example, an electric vehicle, a hybrid vehicle, or a plug-in hybrid vehicle. The vehicle may be a four-wheel drive vehicle or a two-wheel drive vehicle but is not limited thereto.

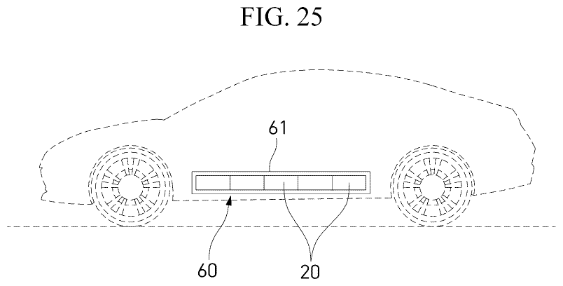

FIG. 25 is a view illustrating the secondary battery pack 60 according to an embodiment of the present disclosure applied to a vehicle.

Referring to FIG. 25, the secondary battery pack 60 is installed on the floor of a vehicle body of a vehicle. The secondary battery pack 60 may include the plurality of secondary battery modules 20 and the pack housing 61. The pack housing 61 accommodates and protects the secondary battery module 20. As described above, because the buffer unit 40 is installed under the secondary battery module 20, a coolant does not leak from the secondary battery module 20 even when an impact is applied to the secondary battery pack 60 while the vehicle travels.

From the foregoing, a secondary battery module and a secondary battery pack according to embodiments of the present disclosure has a compact structure and reduced volume because a module case of the secondary battery module has a structure for cooling a battery cell.

In addition, because a buffer unit is provided outside the module case, a battery cell and a coolant flow path may be protected from an external impact, thereby preventing a problem, such as coolant leak or the like.

Although the present disclosure has been described above in connection with embodiments thereof, the present disclosure is not limited thereto. Various modifications and variations can be made thereto by those skilled in the art within the spirit of the present disclosure as defined by the appended claims and their equivalents.

What is claimed is:

1. A secondary battery module comprising:
a plurality of battery cells;
a module case having a plurality of cell pockets into which the battery cells are fitted and a coolant passage outside the cell pockets through which a coolant flows to cool the battery cells in the cell pockets; and
a coolant circulation part connected to the module case and configured to move the coolant through the coolant passage inside of the module case.

2. The secondary battery module as claimed in claim 1, wherein the plurality of cell pockets are parallel to each other and spaced from each other, and
wherein the module case comprises an exhaust duct having a vent passage corresponding to a vent in each of the battery cells, the exhaust duct being inside the module case and extending outwardly from the module case.

3. The secondary battery module as claimed in claim 2, wherein the coolant passage of the module case comprises:
an inflow flow path configured to receive and guide the coolant introduced by the coolant circulation part;
a heat exchange flow path connected to the inflow flow path and configured to allow the coolant to pass through a space between adjacent ones of the cell pockets; and
a discharge flow path configured to guide the coolant that has passed through the heat exchange flow path to an outside of the module case.

4. The secondary battery module as claimed in claim 3, wherein the module case further comprises a reinforcing part formed on a surface of the cell pockets facing the heat exchange flow path, the reinforcing part being configured to prevent the cell pockets from being deformed when the battery cell swells.

5. The secondary battery module as claimed in claim 3, wherein the module case further comprises a heat transfer fin on an outer surface of the cell pocket, the heat transfer fin configured to perform heat exchange with the coolant passing through the heat exchange flow path.

6. The secondary battery module as claimed in claim 2, wherein the module case comprises a plurality of the module cases in a stacked structure, and
wherein the coolant passages of vertically neighboring ones of the module cases are connected through a connection duct.

7. The secondary battery module as claimed in claim 1, wherein the module case further comprises a buffer unit on a lower portion of the module case, the buffer unit being configured to protect the module case from an impact transferred from an outside.

8. The secondary battery module as claimed in claim 7, wherein the buffer unit comprises:
a protective guard fixed to the lower portion of the module case;
a protective plate in an inner area of the protective guard and covering a bottom surface of the module case; and
a buffer part between the bottom surface of the module case and the protective plate.

9. The secondary battery module as claimed in claim 1, wherein the cell pockets open upwardly and are spaced parallel to each other.

10. The secondary battery module as claimed in claim 9, wherein the coolant passage of the module case comprises:
an inflow flow path configured to receive and guide the coolant introduced by the coolant circulation part;
a heat exchange flow path connected to the inflow flow path and configured to allow the coolant to pass through a space between adjacent ones of the cell pockets; and
a discharge flow path configured to guide the coolant that has passed through the heat exchange flow path to an outside of the module case.

11. The secondary battery module as claimed in claim 10, wherein the module case further comprises a reinforcing part on a surface of the cell pocket facing the heat exchange flow path, the reinforcing part being configured to prevent the cell pocket from being deformed when the battery cell swells.

12. The secondary battery module as claimed in claim 10, wherein the module case further comprises a heat transfer fin on an outer surface of the cell pocket, the heat transfer fin being configured to perform heat exchange with the coolant passing through the heat exchange flow path.

13. A secondary battery pack comprising:
a secondary battery module comprising a plurality of battery cells, a module case having a plurality of cell pockets into which the battery cells are fitted and a coolant passage outside the cell pockets so that a coolant cools the battery cells in the cell pockets, and a coolant circulation part connected to the module case and configured to move the coolant through the coolant passage inside of the module case; and
a pack housing accommodating the secondary battery module.

14. The secondary battery pack as claimed in claim 13, wherein the plurality of cell pockets are parallel to each other and spaced from each other, and
wherein the module case comprises an exhaust duct having a vent passage corresponding to a vent hole in each of the battery cells, the exhaust duct being inside the module case and extending outwardly from the module case.

15. The secondary battery pack as claimed in claim 13, wherein the coolant passage of the module case comprises:
an inflow flow path configured to receive and guide the coolant introduced by the coolant circulation part;
a heat exchange flow path connected to the inflow flow path and configured to allow the coolant to pass through a space between the cell pockets; and
a discharge flow path configured to guide the coolant that has passed through the heat exchange flow path to an outside of the module case.

16. The secondary battery pack as claimed in claim 15, wherein the module case further comprises a reinforcing part inside the heat exchange flow path, the reinforcing part being configured to prevent the cell pocket from being deformed when the battery cell swells.

17. The secondary battery pack as claimed in claim 15, wherein the module case further comprises a heat transfer fin on an outer surface of the cell pocket, the heat transfer fin being configured to perform heat exchange with the coolant passing through the heat exchange flow path.

18. The secondary battery pack as claimed in claim 13, wherein the module case comprises a plurality of the module cases having a stacked structure, and
wherein the coolant passages of vertically neighboring ones of the module cases are connected through a connection duct.

19. The secondary battery pack as claimed in claim 13, wherein the module case comprises a buffer unit on a lower portion of the module case, the buffer unit configured to protect the module case from an impact transferred from an outside.

20. The secondary battery pack as claimed in claim 19, wherein the buffer unit comprises:
a protective guard fixed to the lower portion of the module case;
a protective plate in an inner area of the protective guard and covering a bottom surface of the module case; and
a buffer part between the bottom surface of the module case and the protective plate.
